(19) United States
(12) Patent Application Publication
(10) Pub. No.: US 2015/0161603 A1
(43) Pub. Date: Jun. 11, 2015

(54) Determining Merchant Identity for Received Merchant Identifiers

(71) Applicant: GOOGLE INC., MOUNTAIN VIEW, CA (US)

(72) Inventor: Amir Fish, Palo Alto, CA (US)

(21) Appl. No.: 14/507,770

(22) Filed: Oct. 6, 2014

(30) Foreign Application Priority Data
Dec. 5, 2013 (IL) 229832

(51) Int. Cl. G06Q 20/40

(52) U.S. Cl. CPC G06Q 20/40

(57) ABSTRACT

A merchant identification system determines the identity of a merchant that is associated with a merchant identifier. When a user makes a purchase at a merchant, the merchant identification system receives a merchant identifier that is unique to the merchant, along with information regarding the purchase transaction. Based on the information, the merchant identification system determines the location of a user device of the user at the time of the purchase transaction. The merchant identification system then determines a candidate identity of the location of the purchase transaction, such as the name of the merchant. After determining additional candidate identities for the location, the merchant identification system determines the expected identity of the actual merchant involved in the purchase transaction. If the merchant identification system later receives a merchant identifier, the merchant identification system can retrieve the identity of the merchant from a record to identify the merchant.

### CROSS REFERENCE TO RELATED APPLICATIONS

This patent application claims priority to Israel Patent Application No. 229832, filed Dec. 5, 2013, and entitled “Determining Merchant Identity for Received Merchant Identifiers.” The entire disclosure of the above-identified priority application is hereby fully incorporated herein by reference.

### TECHNICAL FIELD

The present disclosure relates generally to determining the identity of a merchant corresponding to a received merchant identifier, and more particularly to determining the identity of a merchant associated with a merchant identifier based on the location of a user device at the time of a purchase transaction with the merchant.

### BACKGROUND

In a conventional commercial transaction involving a financial account of a user, such as a credit card of the user, a merchant's point-of-sale terminal or online payment processing engine receives the user's payment of information. The merchant then submits a payment request, such as a transaction authorization request, to an acquirer for payment for the transaction. The transaction authorization request typically includes, for example, a merchant identifier, such as a merchant code or number, for the merchant conducting the transaction. Based on the merchant identifier, the acquirer and financial account issuer process the transaction authorization request for the merchant, and—upon approval of the transaction authorization request—the user and the merchant complete the purchase transaction.

Although acquiring banks, for example, may know the identity of the actual merchant involved in the purchase transaction, other systems involved in the transaction—or other systems that have a commercial interest in the transaction—usually do not know the actual identity of the merchant involved in the purchase transaction. In other words, while the merchant identifier corresponds to a particular merchant, the location and identity of the actual merchant to which the identifier belongs may be generally unknown.

Without knowing the identity of a merchant, a system that processes offers or manages loyalty rewards programs for a user, for example, may not know from the merchant identifier alone where the user actually completed a purchase transaction. For example, even after receiving a merchant identifier, such systems may not know whether a user completed a transaction at a merchant storefront located on Market Street or on Liberty Street in a particular town. Hence, determining offer redemptions, managing loyalty programs, and tying advertisement impressions for particular merchant locations is often not possible based on the received merchant identifier for the location.

In some instances, acquiring banks may provide the merchant identities associated with merchant identifiers. But, obtaining such information can be burdensome and time-consuming for both the acquirer and the entity seeking to obtain such information. Further, if merchants change their merchant identifier, the identity of the merchant corresponding to the new identifier will remain unknown to those other than the acquirer—until the acquirer provides updated information including the new merchant identifier. Hence, merchant identity information obtained from acquirers may be become outdated unbeknownst to an entity relying on the information.

### SUMMARY

In certain example aspects described herein, a computer-implemented method for determining merchant identities for merchant identifiers is provided. For example, a merchant identification system receives merchant identifiers for multiple of merchants. Each of the received merchant identifiers, for example, is associated with a particular merchant and also with a purchase transaction involving a particular user at the particular merchant. The merchant identification system then determines, for each of at least a portion of the received merchant identifiers for a particular merchant, a location of a user computing device of the particular user involved in the purchase transaction. The determined location corresponds to the location of the user computing device at the time of the purchase transaction with the particular merchant.

The merchant identification system also determines, based on the determined location of one or more user computing devices at the time of the purchase transaction, one or more candidate merchant identities for the particular merchant associated with the purchase transaction. The merchant identification system then associates the one or more candidate merchant identities with the received merchant identifier for the purchase transaction. Then, when a threshold number of matching candidate identities are associated with the received merchant identifier, the merchant identification system determines a merchant identity of the particular merchant associated with the received merchant identifier. The determined merchant identity corresponds to at least one of the matching candidate merchant identities.

In certain other example aspects, a system for determining merchant identities for merchant identifiers is also provided. Also provided in certain aspects is a computer program product for determining merchant identities for merchant identifiers.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system for determining a merchant identity associated with a merchant identifier, in accordance with certain example embodiments.

FIG. 2 is a block flow diagram depicting a method for determining a merchant identity associated with a merchant identifier, in accordance with certain example embodiments.

FIG. 3 is a block flow diagram depicting a method for receiving a merchant-specific identifier for a purchase transaction of a user, in accordance with certain example embodiments.

FIG. 4 is a block flow diagram depicting a method for determining a merchant identity from a merchant identifier database, in accordance with certain example embodiments.

FIG. 5 is a block diagram depicting a computing machine and a module, in accordance with certain example embodiments.

### DETAILED DESCRIPTION OF THE EXAMPLE EMBODIMENTS

### Overview

As disclosed herein, a merchant identification system determines the identity of a merchant that is associated with a merchant identifier. Multiple users, for example, register with the merchant identification system, thus allowing the merchant identification system to receive location information from user computing devices belonging to the registered users. When a particular, registered user makes a purchase at a merchant storefront, for example, the merchant identification system receives a merchant identifier that is unique to the merchant, such as a merchant storefront number. The merchant identification system also receives information that can be used to identify the registered user, such as a user financial account associated with the purchase transaction.

Based on the identity of the registered user, the merchant identification system determines the location of the user device of the registered user at the time of the purchase transaction. The merchant identification system then determines a candidate identity of the location of the purchase transaction, such as the name of the merchant at the storefront location. After determining additional candidate identities for the location, the merchant identification system determines the expected identity of the actual merchant involved in the purchase transaction. The merchant identification system then associates the merchant identity with the merchant identifier, such as in a record of merchant identities. If the merchant identification system later receives a merchant identifier, the merchant identification system can retrieve the identity of the merchant from the record to identify the merchant.

More particularly, in certain examples users may decide to register with the merchant identification system. That is, a particular user may provide the user's name and other information so that the merchant identification system can create an account (or record) for the user. As part of the registration, the user may also provide information to the merchant identification system so that the merchant identification system can identify and locate the user computing device of the user, such as a mobile phone of the user. In certain examples, the user may also associate one or more financial accounts with the merchant identification system, in which case the merchant identification system may act as a custodian of the user's one or more financial accounts. For example, the user may create a digital wallet account with the merchant identification system. The user can then employ the digital wallet account, for example, to complete purchase transactions of the user.

As part of the registration, and to obtain the benefits of the methods and techniques described herein, the user may have to select a setting on the user computing device—or install an application on the user device—that allows the merchant identification system to receive location data from the user device of the user. The user may install, for example, a merchant identification application on the user device, which permits the merchant identification system to receive location data from the user device, such as location information for the user device at the time of a purchase transaction of the user with a merchant.

Following user registration, a particular, registered user initiates a purchase transaction with a particular merchant. For example, the registered user selects a product and presents the product for purchase at a merchant point-of-sale terminal of a merchant system. To purchase the product from the merchant, the registered user may swipe a magnetic strip card with the merchant, which includes the user's financial account information. In certain examples, the registered user may provide the merchant a financial payment account that is associated with the merchant identification system, such as an associated digital wallet account of the registered user. To receive the user financial account information, the merchant may manually enter the user account number from a user interface of the user device of the registered user. Additionally or alternatively, the merchant may receive the registered user account information from the user device by any other means, such as via near-filed communication (“NFC”).

Based on the financial account information received from the registered user and/or the registered user's computing device, the merchant system, for example, generates purchase transaction information regarding the purchase transaction. For example, the merchant creates a transaction authorization request for the purchase transaction, which includes information regarding the purchase transaction. For example, the authorization request includes the financial account information of the registered user, which the custodian of the financial account can use to identify the registered user associated with the purchase transaction. The authorization request also includes a merchant identifier that is unique to the particular merchant conducting the purchase transaction, such as a number or code that corresponds to the particular merchant. The authorization request also includes, for example, information regarding the purchase transaction, such as the time the purchase transaction occurred.

After generating the purchase transaction information, such as a transaction authorization request, the merchant system transmits the transaction authorization request to the custodian of the financial account of the registered user, such as to the issuer of the user's financial account. For example, the merchant transmits the authorization request indirectly or directly to the custodian of the financial account through traditional credit card channels and/or through Transmission Control Protocol (TCP)/Internet Protocol (IP). The custodian then receives the transaction authorization. In examples where the merchant identification system is the custodian of the registered user's financial account, the merchant identification system may receive the transaction authorization request from the merchant, directly and/or indirectly. By then matching the registered user financial account information received in the request with record for the registered user, such as with the digital wallet account of the user, the merchant identification system can, for example, identify the registered user associated with the purchase transaction.

In certain embodiments, such as when the merchant identification system is not the custodian of the registered user financial account, the merchant identification system may receive information regarding the purchase transaction of the registered user from the issuer of the financial account. For example, after receiving a transaction authorization request, the issuer of the financial account may provide the merchant identification system with the merchant identifier associated with the purchase transaction, as well as the identity of the registered user and the time of the purchase transaction. In other examples, the issuer of the financial account may provide such information to the merchant identification system after transaction with the merchant is authorized and completed, such as when the purchase transaction is cleared.

After the merchant identification system receives the purchase transaction information for purchase transaction of the particular, registered user with the merchant, the merchant identification system determines the location of a user device belonging to the registered user at the time of the purchase transaction. For example, based on the identity of the registered user, the merchant identification system identifies a computing device of the registered user, such as a mobile phone belonging to the registered user. The merchant identification system then determines the location of the user device at the time of the purchase transaction. In other words, based on the time of the purchase transaction—as determined from the received purchase transaction information—the merchant identification system determines the location of the user device at the time corresponding to the time of the purchase transaction. For example, the determined location may comprise latitude and longitude coordinates for the user device at the time of the purchase transaction.

In certain examples, the merchant identification system determines the location of the user device using fine-grained location data. That is, the location data may be highly accurate and hence identify the location of the user device to within a few feet or even a few inches. Once the merchant identification system determines the location of the user device at a particular merchant at the time of the purchase transaction, the merchant identification system can be stripped of any user identifying information. As such, the merchant identification system may process and store only data showing that a device (without knowing which device) was at a determined location at the time of a purchase transaction occurring at the location.

Based on the determined location of the user device at the time of the purchase transaction involving the registered user, the merchant identification system determines a candidate merchant identity for the location corresponding to the determined user device location. That is, after the merchant identification system determines the location of the user device, such as the latitude and longitude coordinates of the user device at the time of the purchase transaction, the merchant identification system determines the identity of the merchant located at or near the determined latitude and longitude coordinates. For example, the merchant identification system may determine the name of the merchant storefront corresponding to the determined location, such as “John Doe's Steakhouse.” The merchant identification system may also determine additional identifying information for the merchant, such as the street address for the merchant. For example, the merchant identification system may determine—based on location of the user device at the time of the purchase transaction—that the registered user was likely at “John Doe's Steakhouse at 1115 Market Street” at the time of the purchase transaction.

After determining a candidate identity for the determined location of the user device at the time of the purchase transaction, the merchant identification system associates the candidate merchant identity with the merchant identifier received for the purchase transaction. That is, the merchant identification system links the candidate merchant identity to the received merchant identifier, such as in a record for the merchant identifier. For example, the merchant identification system may receive purchase transaction information that includes a merchant identifier, such as “JDSH12345678.” Based on the location of the user device at the time of the purchase transaction, the merchant identification system determines, for example, that the candidate merchant identity for the location “John Doe's Steakhouse at 1115 Market Street.” The merchant identification system thus associates the candidate merchant identity—“John Doe's Steakhouse at 1115 Market Street”—with the merchant identifier “JDSH12345678,” such as in a record for the merchant identifier “JDSH12345678.”

Once the merchant identification system associates a candidate merchant identity with the received merchant identifier, the merchant identification system determines additional candidate merchant identities for the received merchant identifier until a threshold number of matching candidate merchant identities is attained. That is, the merchant identification system receives purchase transaction information for one or more additional purchase transactions involving the same merchant identifier. Then, as described herein, the merchant identification system determines—for the registered users involved in the purchase transactions—the location the user devices at the time of the one or more purchase transaction. The merchant identification system then determines additional candidate identities for the determined locations, which the merchant identification system then associates with the received merchant identifier. The merchant identification system then determines for the same merchant identifier whether a threshold number of matching candidate merchant identities—that is, candidate merchant identities that correspond to the same candidate identity—are associated with the merchant identifier.

For example, based on a particular purchase transaction, the merchant identification system may initially associate “John Doe's Steakhouse at 1115 Market Street” with merchant identifier “JDSH12345678” as described above. As the merchant identification system continues to receive purchase transactions involving merchant identifier “JDSH12345678,” the merchant identification system continues to determine candidate merchant identities for merchant identifier “JDSH12345678.” For example, the merchant identification system may receive purchase transaction information for four additional purchase transactions involving merchant identifier “JDSH12345678.” And, for each of the four additional purchase transactions, the merchant identification system may determine that the candidate identity for the location of the purchase transaction is “John Doe's Steakhouse at 1115 Market Street.” That is, in this example, all of the candidate merchant identities (a total of five) match each other. In other words, all of the candidate merchant identities correspond to “John Doe's Steakhouse at 1115 Market Street.”

Based on the number of candidate merchant identities that match each other, the merchant identification system determines whether a threshold number of matching candidate identities are associated with the merchant identifier. For example, if the threshold number of matching candidate merchant identities is ten, then the merchant identification system determines whether ten matching candidate merchant identities are associated with the merchant identifier. If ten matching candidate merchant identities are associated with the merchant identifier, the merchant identification system then proceeds to determine the expected identity of the actual merchant associated with the merchant identifier as described below. But if the merchant identification system determines that the threshold number of matching candidate merchant identities associated with the merchant identifier has not been met, the merchant identification system continues to determine additional candidate identities to associate with the merchant identifier.

Continuing with the above example, if the threshold number of matching merchant identities is ten, then because only five matching candidate merchant identities are associated with the merchant identifier “JDSH12345678,” the merchant identification system determines that the threshold number is not met. Hence, the merchant identification system continues to determine additional candidate identities to associate with the merchant identifier, such as merchant identifier “JDSH12345678” in this example. In contrast, if the threshold number of matching candidate merchant identities is five, then the merchant identification system determines—based on the five matching “John Doe's Steakhouse at 1115 Market Street” candidate merchant identities associated with merchant identifier “JDSH12345678”—that the threshold number has been met. The merchant identification system thus proceeds to determine, as described below, that the expected identity of the actual merchant is “John Doe's Steakhouse at 1115 Market Street” for the merchant identifier “JDSH12345678.”

By determining a threshold number of matching candidate identities associated with a merchant identifier, the merchant identification system increases the likelihood of accurately identifying the actual merchant associated with the merchant identifier. For example, in a location where multiple merchants may be crowded together, more matching candidate merchant identities may be desired to more accurately determine the identity of the actual merchant associated with the merchant identifier. In other words, because of the multiple merchants in the area, in some instances the merchant identification system may determine candidate merchant identities of a received merchant identifier that do not match. Hence, the more matching candidate identities that the merchant identification system subsequently determines, the more accurately the merchant identification system can determine the expected identity of the actual merchant for the received merchant identifier.

In other examples, such as in areas that are sparsely populated with merchants, fewer matches may be needed. For example, only two candidate merchant identities that match each other for the received merchant identifier may be needed. In additional examples, such as when the merchant identification system relies on fine-grained location data, fewer matching candidate merchant identities may be needed, even for areas densely populated areas.

Once the merchant identification system determines that the threshold number of matching candidate merchant identities associated with the merchant identifier has been met, the merchant identification system proceeds to determine the expected identity of the actual merchant for the received merchant identifier. That is, once the threshold number of matching candidate merchant identities associated with the received merchant identifier is met, the merchant identification system relies on the matched candidate merchant identities as van indication that the actual identity of the merchant likely corresponds to the one of the matched candidate merchant identities.

For example, if the threshold number is five and the merchant identification system determines that five candidate “John Doe's Steakhouse at 1115 Market Street” identities match each other for merchant identifier “JDSH12345678,” the merchant identification system determines that the expected identity of the actual merchant associated with merchant identifier “JDSH12345678” is “John Doe's Steakhouse at 1115 Market Street.” In certain examples, after determining the expected identity of an actual merchant associated with merchant identifier, the merchant identification system updates a record for merchant identifier. For example, the merchant identification system may update a record for merchant identifier “JDSH12345678,” thus indicating that this merchant identifier corresponds to “John Doe's Steakhouse at 1115 Market Street.”

In certain examples, the merchant identification system determines the expected merchant identity that is associated with multiple received merchant identifiers. The merchant identification system can then, by creating a record for each of the received merchant identifiers for which the corresponding merchant identity has been determined, establish a database of merchant identifiers. The merchant identification system can then rely on the database to identify merchants for subsequently received merchant identifiers.

For example, in certain examples the merchant identification system receives a subsequent merchant identifier for which additional purchase transaction information may or may not be known. If a user makes a purchase at a particular merchant, for instance, in some examples the merchant identification system may receive only a merchant identifier from an acquiring bank without additional information. But, regardless of whether such purchase transaction information is known, when the merchant identification system receives the subsequent merchant identifier, the merchant identification system determines whether the subsequent merchant identifier matches any of the stored merchant identifiers in the database. If so, the merchant identification system can identify the merchant associated with the received merchant identifier by reading the identity of the merchant associated with the matched merchant identifier.

By using and relying on the methods and systems described herein, the merchant identification system (or another system affiliated with the merchant identification system) may use the determined merchant identity for the merchant identifier for a variety of commercial purposes. For example, by knowing where purchase transactions for received merchant identifiers are occurring, the merchant identification system can determine the purchase transaction volumes at particular merchants and hence determine whether focused advertising campaigns are successful for the identified merchant associated with the merchant identifier. The merchant identification system (or other systems) can also use the determined merchant identity for the merchant identifier to manage user loyalty reward programs. For example, knowing that a registered user conducted a purchase transaction at a particular merchant may allow the merchant identification system (or affiliated entity) to automatically provide the registered user with loyalty points for shopping at the particular merchant.

### Example System Architectures

Turning now to the drawings, in which like numerals indicate like (but not necessarily identical) elements throughout the figures, example embodiments are described in detail.

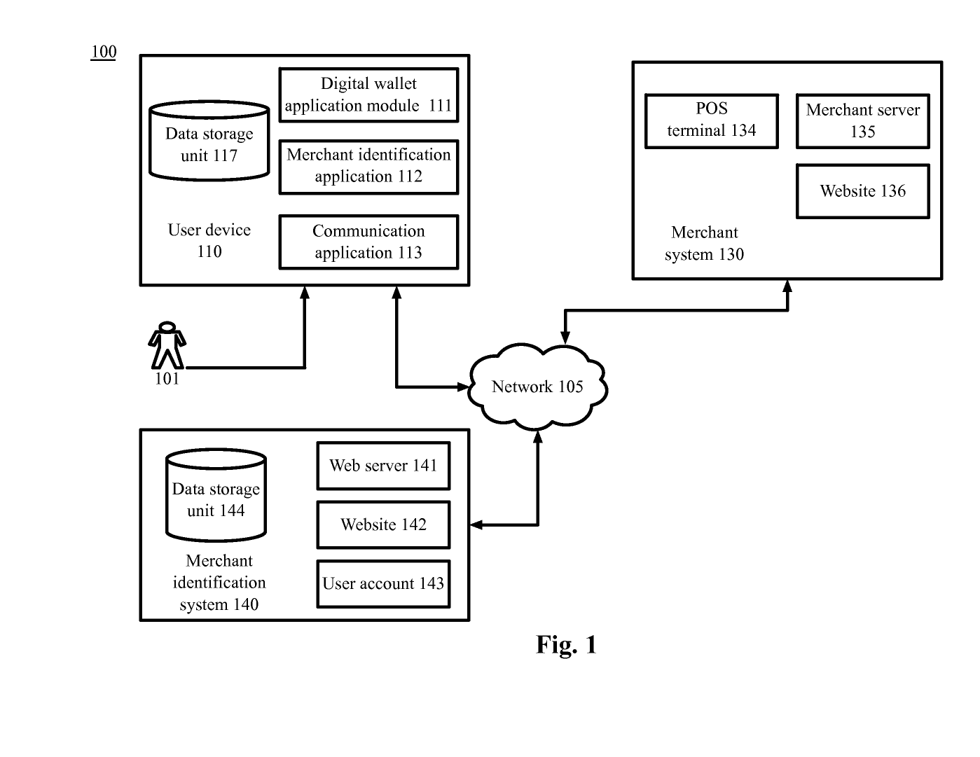

FIG. 1 is a block diagram depicting a system 100 for determining a merchant identity associated with a merchant identifier, in accordance with certain example embodiments.

As depicted in FIG. 1, the exemplary operating environment 100 includes a user network computing device 110, a merchant computing system 130, and a merchant identification system 140 that are configured to communicate with one or more of each other via one or more networks 105. In another example embodiment, two or more of these systems (including systems 110, 130, and 140) or parts thereof are integrated into the same system. In some example embodiments, a user 101 associated with a device must install an application and/or make a feature selection to obtain the benefits of the techniques described herein.

Each network 105 includes a wired or wireless telecommunication means by which network devices (including devices 110, 130, and 140) can exchange data. For example, each network 105 can include a local area network (“LAN”), a wide area network (“WAN”), an intranet, an Internet, a storage area network (SAN), a personal area network (PAN), a metropolitan area network (MAN), a wireless local area network (WLAN), a virtual private network (VPN), a cellular or other mobile communication network, Bluetooth, near field communication (NFC), or any combination thereof or any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment.

Each network computing device 110, 130, and 140 includes a device having a communication module capable of transmitting and receiving data over the network 105. For example, each network device 110, 130, and 140 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network devices 110, 130, and 140 are operated by end-users or consumers, merchant system operators, and merchant identification system operators, respectively.

The user 101 can use the communication application 113, such as a web browser application or a stand-alone application, to view, download, upload, or otherwise access documents or web pages via a distributed network 105. The communication application 113 of the user computing device 110 can interact with web servers or other computing devices connected to the network 105. For example, the communication application 113 can interact with the user network computing device 110, the merchant system 130, and/or the merchant identification system 140. The communication application 113 may also comprise a web browser (not shown), which provides a user interface, for example, for accessing other devices associated with the network 105.

The user network device 110 may also include a digital wallet application module 111. The digital wallet application module 111 may encompass any application, hardware, software, or process of the user device 110 that the user 101 may employ to assist the user 101 in completing a purchase transaction with a merchant, such as at a point-of-sale terminal 134 with a merchant. For example, the digital wallet application module 111 can interact with a digital wallet account (not shown) of the merchant identification system 140. The digital wallet application module 111 can interact with the communication application 113 or can be embodied as a companion application of the communication application 112. As a companion application, the digital wallet application module 111 executes within the communication application 112. That is, the digital wallet application module 111 may be an application program embedded in the communication application 113, for example.

The user computing device 110 may include a merchant identification application 112. The merchant identification application 112, for example, communicates and interacts with the merchant identification system 140, such as via the communication application 113. To obtain the benefits of the merchant identification system 140 as described herein, for example, a user 101 may have to download and install the merchant identification application 112 on the user device 110. The merchant identification application 112, for example, may be configured, based on user preferences, to obtain, receive, and communicate location information of the user 101, including fine-grained location data, to merchant identification system 140.

In certain example embodiments, the merchant identification application 112 may be configured to communicate and interact with a location service provider that, in conjunction with the user device 110, facilitates determination of the location of the user device 110. For example, the merchant identification application 112 may, along with a location service and/or hardware of the user device 110, rely on WiFi signals and cellular communication towers to determine the location of the user device 110. Additionally or alternatively, the merchant identification application 112 may rely on satellites, Global Positioning System (“GPS”) location technology, Differential Global Positioning System (“DGPS”), a Network Location Provider (“NLP”), a map application, or other location identifying technology of the user device 110 to determine location history for the user device 110. In certain example embodiments, the merchant identification application 112 can interact with other applications on the user device 110, such as a mapping application (not shown) on the user device 110.

The user computing device 110 may further include a data storage unit 117. The example data storage unit 117 can include one or more tangible computer-readable storage devices. The data storage unit 117 can be a component of the user device 110 or be logically coupled to the user device 110. For example, the data storage unit 117 can include on-board flash memory and/or one or more removable memory cards or removable flash memory. In certain example embodiments, the data storage unit 117 may, at the option of the user, store location data pertaining to the user 101. In certain example embodiments, the data storage unit 117 may include cache memory that can, for example, receive and store location data for the user device 110.

The merchant computing system 130 represents a system that offers products and/or services for the user 101 to purchase or use. For example, the merchant system 130 may be a physical location, such as a merchant storefront where a user 101 may purchase products, or an online store. As used herein, “product(s)” can include, for example, any tangible or intangible products, as well as services.

In certain example embodiments, the merchant system 130 includes a point-of-sale (“POS”) terminal 134, such as a payment terminal or cash register, at a merchant storefront. The point-of-sale terminal 134 may be operated by a salesperson that enters purchase data into the point-of-sale terminal 134 to complete a purchase transaction. For example, the point-of-sale terminal 134 may be equipped to receive financial account information from a user 101, such as from a magnetic-stripe card swipe of the user 101 or from a wireless “tap” of the user device 110 to the point-of-sale terminal 134 or a peripheral device attached thereto.

Affiliated or associated with the merchant system 130 is a merchant system operator (not shown). The merchant computing system 130 may also include a merchant server 135, which in certain example embodiments may represent the computer-implemented system that the merchant system 130 employs to create and assemble a website 136 and content for the website 136. The point-of-sale terminal 134, either alone and/or in conjunction with the merchant server 135, may also represent the computer-implemented system that the merchant system 130 employs to transmit to purchase transaction information, such as transaction authorization requests, to acquires, financial account issuers, credit card networks, and any other entities that may be involved in (or have a commercial interest in) the purchase transaction between the user 101 and the merchant system 130.

The merchant identification system 140 represents a system for determining the identity of a merchant that is associated with a received merchant identifier for the merchant. The merchant identification system 140 is configured to interact with and receive data and information from the user computing device 110 via the network 105. For example, after a user 101 installs a merchant identification application 112 on the user device 110, for example, that allows the merchant identification system 140 to receive user location data from the user computing device 110. The merchant identification system 140 is also configured to communicate with the merchant system 130, such as via the network 105. The merchant identification system 140 may also include a digital wallet account (not shown) of the user 101, which is configured to interact with the digital wallet application module 111 of the user device 110.

The merchant identification system 140 can include a web sever 141, which may represent the computer-implemented system that the merchant identification system 140 employs to determine the identity of a merchant that is associated with a received merchant identifier for the merchant as described herein. The web sever 141, which may also represent the computer-implemented system that the merchant identification system 140 employs to match a received merchant identifier with a record that includes the merchant identifier as described herein. As such, the merchant identification system 140 and associated web server 141 may be configured to receive and/or obtain user device location data that corresponds to the location of the user device 110 at the time of a purchase transaction of the user 101 at a particular merchant of the merchant system 140.

The merchant identification system 140 may also include a website 142 and a user account 143. A user 101, for example, may utilize a user interface of the website 142 to register with the merchant identification system 140 and hence create a record with the merchant identification system 140, such as the user account 143. For example, the user 101 may associate with the user account 143 information about the user 101 that permits the merchant identification system 140 to locate and interact with the user device 110.

The merchant identification system 140 may also include an accessible data storage unit 144. In certain example embodiments, for example, the data storage unit 144 stores received merchant identifiers, along with location information for specific merchant locations that are or may be affiliated with (or associated with) the merchant identifiers. For example, the data storage unit 144 may receive and store location information generated when users 101, with their user computing devices 110, visit various merchants of the merchant system 130 and make purchase transactions. The exemplary data storage unit 144 can include one or more tangible computer-readable media. The data storage unit 144 can be stored on the user device 110 or can be logically coupled to the user device 110. For example, the data storage unit 144 can include on-board flash memory and/or one or more removable memory cards or removable flash memory.

In certain example embodiments, the merchant identification functions of the merchant identification system 140 operate and execute fully and completely on the user device 110, such as within, or as a companion application to, the merchant identification application 112. Alternatively, the merchant identification functions of the merchant identification system 140 may operate and execute separately and independently from the user device 110. For example, merchant identification system 140 may operate and execute within a separate computing system or other computing system that determines merchant identifications as described herein. Alternatively, in other example embodiments the merchant identification functions of the merchant identification system 140 may execute partially on the user device 110 and/or partially on a separate computing system. For example, the merchant identification functions of the merchant identification system 140 may occur both via the merchant identification system 140 and the merchant identification application 112.

It will be appreciated that the network connections shown are examples and that other mechanisms of establishing a communications link between the computers and devices can be used. Additionally, those having ordinary skill in the art and having the benefit of the present disclosure will appreciate that the user device 110, merchant system 130, and merchant identification system 140 in FIG. 1 can have any of several other suitable computer system configurations. For example, a user computing device 110 embodied as a mobile phone or handheld computer may not include all the components described above.

### Example Processes

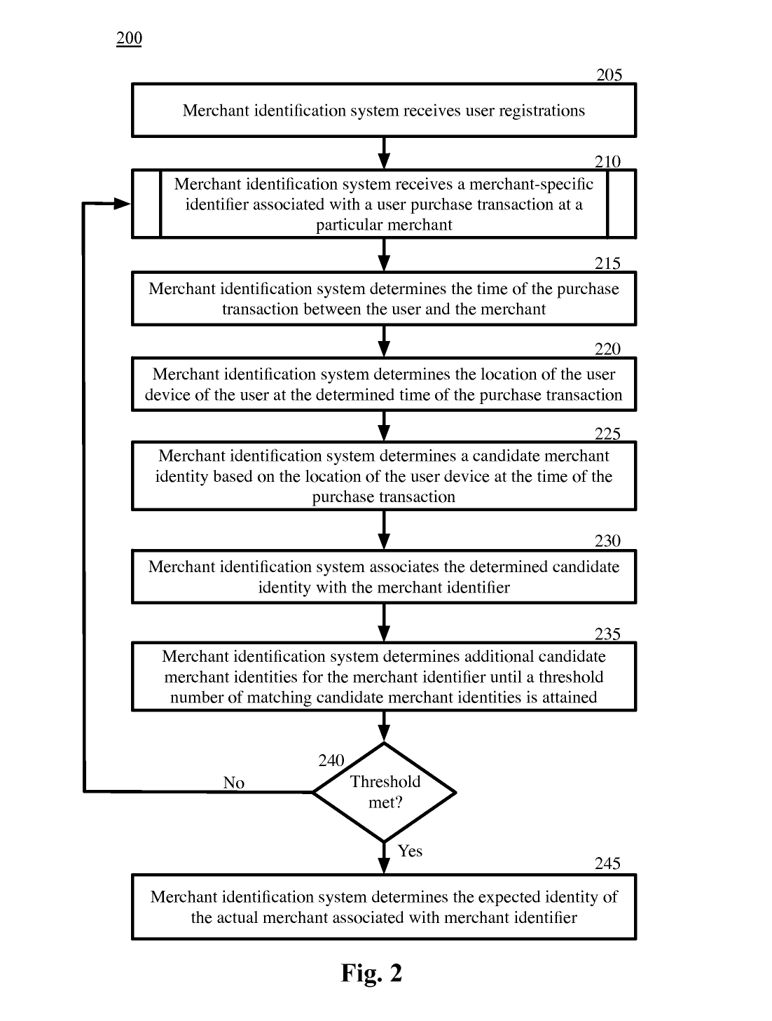

The components of the example operating environment 100 are described hereinafter with reference to the example methods illustrated in FIGS. 2-4.

FIG. 2 is a block flow diagram depicting a method 200 for determining a merchant identity associated with a merchant identifier, in accordance with certain example embodiments.

With reference to FIGS. 1 and 2, in block 205, the merchant identification system 140 receives user 101 registrations from multiple users 101. For example, a user 101 accesses the website 142 of the merchant identification system 140 to request an account. The user device 110 of the user 101 then transmits a request for a user account 143 via the network 105 to the merchant identification system 140, and the merchant identification system 140 receives the request. The merchant identification system 140 then creates an account for the user 101, which provides a record for the particular user 101.

As part of the registration process, a particular user 101 may provide the user's name and other information so that the merchant identification system 140 can receive location information for the user device 110 of the user 101. In certain example embodiments, to obtain the benefits of the methods and techniques described herein, the user 101 may have to select a setting on the user device 110. Additionally or alternatively, the user 101 may have to install an application on the user device 110, such as the merchant identification application 112, which allows the merchant identification system 140 to receive location information for the user device 110 of the registered user 101.

In certain example embodiments, the user may associate with the user account 143 of the merchant identification system 140 a digital wallet account (not shown) of the user 101. For example, the user 101 may associate with the digital wallet account bank account debit cards, credit cards, gift cards, loyalty cards, stored value cards, prepaid cards, store rewards cards, or any other type of financial account that the user 101 can employ to make a purchase or redeem value-added services with a payment account of the user 101. The user 101 may also provide or select rules for the digital wallet account, such as which specific financial account the merchant identification system 140 is to use when making a purchase transaction with the associated user digital wallet account of the user 101. In certain example embodiments, the user account 143 may include an account number associated with user's digital wallet account, which the user 101 can provide to a merchant system 130 when making a purchase transaction.

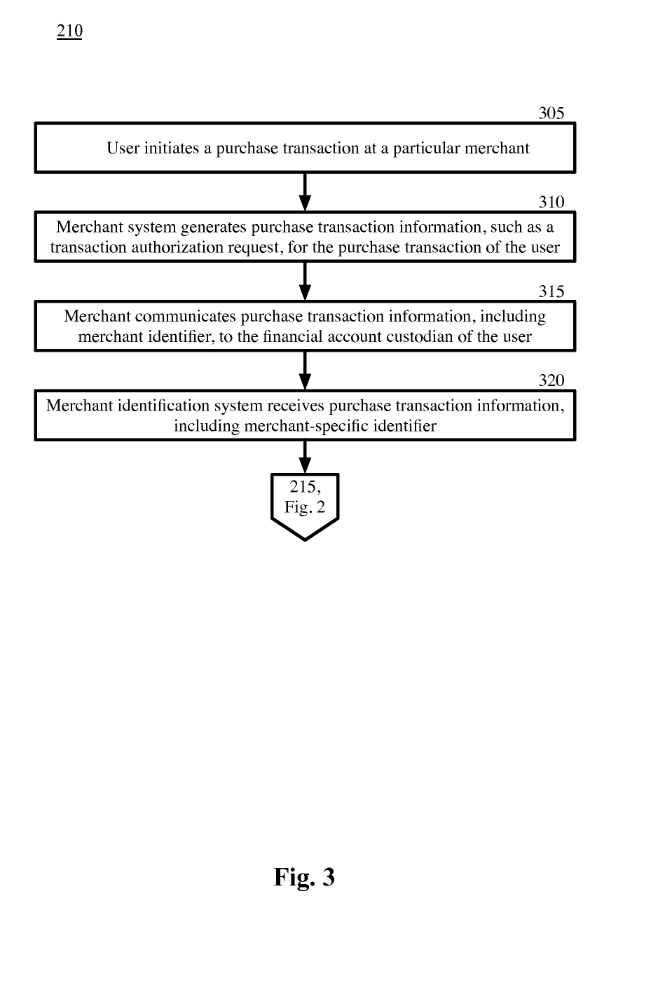

In block 210, the merchant identification system 140 receives a merchant-specific identifier associated with a user purchase transaction at a particular merchant. The merchant identification system 140, for example, may receive the merchant specific identifier in any number of ways. In certain example embodiments, a registered user 101 utilizes a financial account of the user 101 to initiate a purchase transaction with an operator (not shown) of a particular merchant point-of-sale terminal 134. The merchant point-of-sale terminal 134 receives the financial account information of the user 101, and transmits the purchase transaction information to custodian of the financial account, such as through an acquiring bank of the merchant system 130. The merchant identification system 140 then receives the purchase transaction information, which includes a specific merchant identifier that is unique to the particular merchant point-of-sale terminal 134 conducting the purchase transaction. Example details of block 210 are described hereinafter with reference to FIG. 3.

FIG. 3 is a block flow diagram depicting a method 210 for receiving a merchant-specific identifier for a purchase transaction of a user 101, as referenced in block 210 of FIG. 2.

With reference to FIGS. 1 and 2, in block 305 of method 210, a user 101 initiates a purchase transaction at a point-of-sale terminal 134 of a merchant system 130. For example, a user 101 selects a product at a merchant storefront, and presents the product to the merchant system 130. The product, for example, comprises any tangible or intangible product, and includes any services that a merchant system 130 provides. The user 101, for example, may present the product to an operator of a merchant system (not shown), such as an operator of a point-of-sale (“POS”) terminal 134 of a merchant system 130.

As part of initiating the purchase transaction, the user 101 also provides financial account information to the merchant system 130 as a means for paying for the product. In certain embodiments, the user 101 may provide a financial account associated with the user account 143 of the user 101, such as a digital wallet account of the user 101. To provide the financial account information to the merchant system 130, the user 101 can swipe a magnetic stripe card of the user 101 at the point-of-sale terminal 134, which includes financial account information of the user 101 such as an account number of the user 101.

Additionally or alternatively, the user 101 relies on the user device 110 to communicate the financial account information to a merchant computing device via near field communication (“NFC”), barcode, Wi-Fi, infrared, an Internet connection over the network, or any suitable technology. Additionally or alternatively, the user can swipe or “tap” the user device 110 to a merchant system computing device to provide the financial account information of the user 101. Additionally or alternatively, the user 101 can show the financial account information of the user merchant employ (operator) or merchant scanner. The user 101 can also provide the merchant system 130 with any other information needed to complete the purchase transaction. The merchant system 130 then receives the financial account information of the user 101.

In block 310, the merchant system 130 generates purchase transaction information, such as a transaction authorization request, for the purchase transaction of the user 101 involved in the purchase transaction. That is, based on the financial account information received from the user 101, the merchant system 130 creates and/or assembles information needed to charge the user financial account of the user 101 for the purchase transaction.

The purchase transaction information, such as a transaction authorization request, includes information that can be used to identify the user 101. For example, a transaction authorization request may include the user account number associated with the financial account of the user 101. The purchase transaction information also includes a merchant identifier that is unique to the specific merchant conducting the purchase transaction with the user 101. For example, the merchant identifier may include any number and/or code that is associated with the particular merchant, such as a combination of numbers, letters, and/or other characters. The purchase transaction information also includes, for example, information regarding the purchase transaction, such as the date and time of the purchase transaction between the user 101 and the merchant point-of-sale terminal 134 of the merchant system 130.

In block 315, the merchant system 130 communicates the purchase transaction information to financial account custodian of the user 101. For example, after the merchant system 130 generates a transaction authorization request, the merchant system 130 communicates the transaction authorization request, including the merchant-specific identifier, directly and/or indirectly to the custodian of the financial account employed in the purchase transaction. For example, the point-of-sale terminal 134 for the merchant system 130 relies on conventional credit card processing channels to communicate the purchase transaction information to the issuer of the financial account (such as through an acquiring bank of the merchant system 130 and the card network of the financial account). Additionally or alternatively, the merchant system 130 communicates the purchase transaction information to the custodian of the financial account via a Transmission Control Protocol (TCP)/Internet Protocol (IP). The custodian of the financial account of the user 101 then receives the purchase transaction information.

In block 320, the merchant identification system 140 receives purchase transaction information, including merchant-specific identifier. For example, in certain example embodiments where the merchant identification system 140 is not the custodian of the financial account that the user 101 employed when making the purchase transaction, the merchant identification system 140 receives the purchase transaction information indirectly, such as from the issuer of the financial account (not shown). That is, the issuer of the financial account communicates the purchase information to the merchant identification system 140 such as via the network 105 when the issuer of the financial account receives a transaction authorization request from the merchant system. In certain other example embodiments, the issuer of the financial account may provide the purchase transaction information to the merchant identification system 140 after the transaction with the merchant system 130 is authorized and completed, such as when the purchase transaction is cleared.

In certain other example embodiments, the merchant identification system 140 may operate as the custodian of the financial account that the user 101 employed in the purchase transaction, such as when the user 101 pays with a digital wallet account associated with the user account 143. In such example embodiments, the merchant identification system 140 may receive the purchase transaction information directly from the point-of-sale terminal 134 of the merchant system 130. In certain other example embodiments, an acquiring bank associated with the merchant system 130 may communicate the purchase transaction information to the merchant identification system 140. The merchant identification system 140 thus receives the purchase transaction information, including the merchant-specific identifier for the particular merchant involved in the purchase transaction with the user 101. The method then follows to block 215 of method 200, in accordance with certain example embodiments.

Returning to block 215 of FIG. 2 of method 200, the merchant identification system 140 determines the time of the purchase transaction between the user 101 and the merchant system 130. For example, if the purchase transaction information includes a time for the purchase transaction between the user 101 and the merchant system 130, the merchant identification system 140 determines time of the purchase transaction based on the purchase transaction information. In certain example embodiments, the purchase transaction information may include the date and time that a transaction authorization request, for example, was transmitted from the merchant system 130 to the acquiring bank of the merchant system 130. In which case, the merchant identification system 140 may determine that the time of the purchase transaction coincides with the time the merchant identification system 140 transmitted the authorization request. Additionally or alternatively, when the merchant identification system 140 operates as the custodian of the financial account employed in the purchase transaction, the merchant identification system 140 may determine that the time of the purchase transaction coincides with when the merchant system 130 transmitted purchase transaction information to the merchant identification system 140.

In block 220, based on the determined time of the purchase transaction, the merchant identification system 140 determines the location of the user device 110 at the time of the purchase transaction. That is, because the user 101 made a purchase associated with a merchant system 130, such as at a point-of-sale terminal 134 of the merchant system 130, the merchant identification system 140 presumes that the user device 110 belonging to the user 101 was with the user 101 during the purchase transaction. For example, in certain embodiments the user 101 may have used the user device 110 to initiate the purchase transaction has described herein. Hence, the merchant identification system 140 thus presumes the location of the user device—at the determined time of the purchase transaction—likely coincides with the location of the merchant location involved in the purchase transaction with the user 101.

To determine the location of the user device 110 at the time of the purchase transaction, the merchant identification system 140 relies on the purchase transaction information to identify the user device 110 corresponding to the user 101 involved in the purchase transaction. For example, the merchant identification system 140 may match a financial account number received in the purchase transaction information against stored user accounts 143 to identify the user 101—and hence the user device 110—associated with the user 101 involved in the purchase transaction. In certain other example embodiments, a custodian of the financial account may provide information to the merchant identification system 140 that allows the merchant identification system 140 to obtain the location of the user device 110 for the user 101 that was involved in the purchase transaction.

Once the merchant identification system 140 determines the user device 110 of the user 101 involved in the purchase transaction, the merchant identification system 140 obtains the location of the user device 110 at the determined time of the purchase transaction. For example, a location application (not shown) on the user device 110, such as the merchant identification application 112 in certain example embodiments, determines the location of the user device 110, such as the latitude and longitude coordinates of the user device 110. The location application may associate with a location-based service to determine the location of the user device 110. The location provider and/or the user device 110, for example, may rely on WiFi signals, cellular communication data, satellites, a Global Positioning System (“GPS”) location technology, a Network Location Provider (“NLP”), a map application, or other location identifying technology of the user device 110 to determine the user device location.

Additionally or alternatively, the location data for the user device 110 may comprise any other suitable location data, such as the street address for the user device 110 or Ordnance Survey Grid Reference information for the user device 110. The location application, for example, communicates the location data to the merchant identification system 140, and the merchant identification system 140 receives the location data. In certain example embodiments, the merchant identification system 140 converts location data to latitude and longitude coordinates for the user device 110.

In certain example embodiments, the location application may determine the location of the user device 110 at configurable intervals, and then store the location data in the data storage unit 117 of the user device 110. For example, location data for the user device 110 may be stored in cache memory of the user device 110. The user device 110 can then communicate the stored location data of the user device 110 to the merchant identification system 140, such as via the merchant identification application 112 and/or the communication application of the user device 110. The merchant identification system 140 then receives the location data for the user device 110.

In certain examples, the location data that the merchant identification system 140 receives includes fine-grained location data. For example, the merchant identification system 140 may rely on location data from sources such as a Differential Global Positioning System (“DGPS”). In other words, the location data may be highly accurate and hence be able to identify the location of the user device 110 to within a few feet or even a few inches. For example, the fine-grained location history may place the user device 110 at a specific geographical location within a larger location, such as within a small merchant storefront that is part of a larger sopping mall with several merchants. In other words, the location history may be highly accurate and hence be able to identify the location of the user device 110 to within a few feet or even a few inches.

Based on the received location data from the user device 110 of the user 101 involved in the purchase transaction, the merchant identification system 140 determines the location of the user device 110 at the time corresponding to the determined time of the purchase transaction. In other words, the merchant identification system 140 determines the location of the user device 110 at the determined time of the purchase transaction (and hence when the user device 110 was likely at the merchant with the user device 110).

In certain example embodiments, after determining the location of the user device 110 at the determined time of the purchase transaction, the merchant identification system 140 may store the determined location data in a record for the location, such as in the data storage unit 144 of the merchant identification system 140. The merchant identification system 140 can then later access the stored location history data from the data storage unit 144. In certain example embodiments, the stored location data may be stripped of any user identifying information. As such, the merchant identification system 140 may process and store only data showing that a device (without knowing which device) was at a particular location at the time of a purchase transaction at the location.

In block 225, the merchant identification system 140 determines a candidate merchant identity based on the location of the user device 110 at the determined time of the purchase transaction. That is, after the merchant identification system 140 determines the location of the user device 110 at the time of the purchase transaction, the merchant identification system determines the identity of the merchant, such as a merchant point-of-sale terminal 134, located at or near the determined location of the user device 110. For example, the merchant identification system 140 may obtain the latitude and longitude coordinates of the user device 110 at the time of the purchase transaction. Relying on the latitude and longitude coordinates, the merchant identification system 140 determines the identity of the merchant that corresponds to the latitude and longitude coordinates of the location. In other embodiments, such as when the latitude and longitude coordinates do not directly correspond to an identifiable merchant, the merchant identification system 140 determines the identity of the merchant that is nearest to the coordinates (that is, the merchant that is closest to the coordinates).

For example, the merchant identification system 140 may determine—based on the latitude and longitude coordinates of the user device 110—that the name of the merchant point-of-sale terminal 134 corresponding to the determined coordinates is “John Doe's Steakhouse.” That is, a merchant storefront with the name “John Doe's Steakhouse” corresponds to the latitude and longitude coordinates of user device 110. Alternatively, merchant with the name “John Doe's Steakhouse” is the nearest merchant point-of-sale terminal 134 to the latitude and longitude coordinates of user device 110. In certain example embodiments, the merchant identification system 140 may also determine additional identifying information for the merchant point-of-sale terminal 134, such as the street address for the merchant point-of-sale terminal 134. For example, the merchant identification system may determine—based on location of the user device at the determined time of the purchase transaction—that the user was likely at “John Doe's Steakhouse at 1115 Market Street” at the time of the purchase transaction.

In block 230, the merchant identification system 140 associates the determined candidate merchant identity with the merchant identifier. That is, based on determined candidate merchant identity for the location of the user device 110 at the determined time of the purchase transaction involving the user 101, the merchant identification system 140 links the determined candidate merchant identity with the merchant identifier received for the purchase transaction. As a “candidate” merchant identity, for example, the candidate merchant identity represents a possible identity for the merchant corresponding to the merchant identifier received as part of the purchase transaction information for the purchase transaction. In other words, the candidate merchant identity represents a potential identity for the merchant storefront, such as the merchant point-of-sale terminal 134, associated with the received merchant identifier for the purchase transaction between the user 101 and the merchant point-of-sale terminal 134.

For example, the merchant identification system 140 may receive purchase transaction information that includes a merchant identifier, such as “JDSH12345678.” Based on the received purchase transaction information, the merchant identification system 140 determines the time of the purchase transaction and identifies the user device 110 associated with the user 101 involved in the purchase transaction. The merchant identification system 140 then determines the location of the user device 110 at the time of the purchase transaction.

Based on the determined location of the user device 110 at the determined time of the purchase transaction, the merchant identification system 140 determines that the candidate merchant identity for the location is, for example, “John Doe's Steakhouse at 1115 Market Street.” The merchant identification system thus associates (links) the candidate merchant identity—“John Doe's Steakhouse at 1115 Market Street”—with the merchant identifier “JDSH12345678.” For example, the merchant identification system 140 may store the merchant identifier “JDSH12345678” as associated with “John Doe's Steakhouse at 1115 Market Street” in a record for the received “JDSH12345678” merchant identifier.

In block 235, the merchant identification system 140 determines additional candidate merchant identities for the merchant identifier until a threshold number of matching candidate merchant identities is attained. That is, to increase the likelihood of correctly determining the actual identity of the merchant point-of-sale terminal 134 associated with a merchant identifier, the merchant identification system 140 determines—for multiple purchase transactions involving the same merchant identifier—multiple corresponding candidate merchant identities. The merchant identification system 140 then associates the candidate identities with the merchant identifier until a configurable threshold number of “matching” candidate merchant identities are associated with the merchant identifier. In other words, a certain number of the candidate merchant identities should be the same as other, candidate merchant identities before the configurable threshold number is met.

To determine additional candidate merchant identities, the merchant identification system 140 repeats the methods described herein for blocks 210 through 235 until the threshold number of candidate identities is met. For example, based on an initial purchase transaction, the merchant identification system 140 may initially receive merchant identifier “JDSH12345678,” along with other purchase transaction information. After determining a candidate identity of “John Doe's Steakhouse at 1115 Market Street” for merchant identifier “JDSH12345678,” the merchant identification system continues to receive purchase transactions for merchant identifier “JDSH12345678.” Hence, the merchant identification system continues to determine candidate identities for merchant identifier “JDSH12345678.”

For example, the merchant identification system may receive information for four additional purchase transactions involving merchant identifier “JDSH12345678.” And, for each of the four additional purchase transactions, the merchant identification system may determine that the candidate identity for the location of the purchase transaction is “John Doe's Steakhouse at 1115 Market Street.” That is, in this example, all of the candidate merchant identities (a total of five) match each other. In other words, all of the candidate merchant identities match each other because they correspond to “John Doe's Steakhouse at 1115 Market Street.”

Based on the number of candidate merchant identities that match each other, the merchant identification system 140 determines whether the threshold number of matching candidate identities are associated with the merchant identifier. For example, if the threshold number of matching candidate merchant identities is ten, then the merchant identification system 140 determines whether ten matching candidate merchant identities are associated with the merchant identifier. Likewise, if the threshold number of matching candidate merchant identities is five, the merchant identification system 140 determines whether five matching candidate merchant identities are associated with the merchant identifier.

Continuing with the above example, if the threshold number of matching merchant identities is ten, then because only five matching candidate merchant identities are associated with the merchant identifier “JDSH12345678,” the merchant identification system 140 determines that the threshold number is not met. Hence, the merchant identification system 140 continues to determine additional candidate identities to associate with the merchant identifier “JDSH12345678.” In contrast, if the threshold number of matching candidate merchant identities is five, then the merchant identification system determines—based on the five matching “John Doe's Steakhouse at 1115 Market Street” candidate identities associated with merchant identifier “JDSH12345678”—that the threshold is number of matching has been met. The merchant identification system 140 thus proceeds to determine, as described below, that the expected identity of the actual merchant is “John Doe's Steakhouse at 1115 Market Street” for the merchant identifier “JDSH12345678.”

As used herein, the “threshold number” of matching candidate identities represents any configurable number of matching candidate merchant identities that one skilled in the art would deem sufficient to accurately determine the actual merchant associated with the merchant identifier. The threshold number is configurable, as the number can be set or varied based on operator preferences, such as the preferences of operators of the merchant identification system 140. For example, in certain example embodiments the number of matching candidate merchant identities associated with the merchant identifier be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, or any other number that accurately determines the expected identity of the actual merchant associated with the merchant identifier. In certain example embodiments, only two matching candidate merchant identities are needed to determine the expected identity of the actual merchant associated with the merchant identifier as described herein.

In certain example embodiments, such as in a location where multiple merchants may be crowded together, more matching candidate merchant identities may be desired to more accurately determine the merchant associated with the merchant identifier. For example, about 5, 10, 15, 20, 25, 30, 35, 40, 45, 50 or more matching candidate merchant identities may be desired. In other words, because of the multiple merchants in the area, in some instances the merchant identification system may determine candidate merchant identities of a received merchant identifier that do not match. Hence, the more matching candidate identities that the merchant identification system determines, the more accurately the merchant identification system can determine the expected identity of the actual merchant for the received merchant identifier.

In certain other example embodiments, such as in areas that are sparsely populated with merchants, fewer matches may be needed, such as only two candidate merchant identities that match each other for the received merchant identifier. A gas station, for example, located ten miles from any other merchant may only need to provide only two transaction authorization requests before the expected identity of the actual gas station can be determined and associated with merchant identifier for the gas station. In certain example embodiments, such as when the merchant identification system relies on fine-grained location data, fewer matching candidate merchant identities may be needed, even for areas that are densely populated areas.

In certain example embodiments, only a single candidate merchant identity may be needed to identify the merchant. That is, no matching candidate merchant identities associated with the merchant identifier are needed. Instead, the determined candidate merchant identity for the merchant identifier corresponds to the expected identity for the actual merchant associated with the merchant identifier. In other words, in certain example embodiments the merchant identification system 140 uses the determined candidate merchant identity to determine that expected identity of the actual merchant associated with the received merchant identifier.

If the merchant identification system 140 determines that threshold number of matching candidate identities associated with the merchant identifier is met, the method follows the “yes” branch of block 240 to block 245 of method 200. If, however, the merchant identification system 140 determines that threshold number of matching candidate identities associated with the merchant identifier is not met, the method follows the “no” branch of block 240 to back to block 210. That is, if the merchant identification system 140 determines that threshold number of matching candidate identities associated with the merchant identifier is not met, the merchant identification system 140 continues to obtain additional candidate merchant identities as described herein until the threshold number is met.

In block 245, the merchant identification system 140 determines the expected identity of the actual merchant, such as the merchant point-of-sale terminal 134, associated with merchant identifier. That is, once the merchant identification system determines that the threshold number of matching candidate merchant identities has been met, the merchant identification system proceeds to determine the most likely identity of the merchant, such as the merchant point-of-sale terminal 134, for the received merchant identifier. In other words, the merchant identification system 140 relies on the matched candidate merchant identities as an indication that the actual identity of the merchant likely corresponds to the one of the matched candidate merchant identities.

For example (and continuing with the above example), if the threshold number is five and the merchant identification system determines that five candidate “John Doe's Steakhouse at 1115 Market Street” identities match merchant identifier “JDSH12345678,” the merchant identification system 140 determines that the expected identity of the merchant for merchant identifier “JDSH12345678” is “John Doe's Steakhouse at 1115 Market Street.” In other words, the merchant identification system 140 relies on the five-matching candidate “John Doe's Steakhouse at 1115 Market Street” identities as indicators that the actual identity of the merchant associated with merchant identifier “JDSH12345678” is “John Doe's Steakhouse at 1115 Market Street.”

In certain example embodiments, after the merchant identification system 140 determines the expected identity of the actual merchant associated with the merchant identifier, the merchant identification system 140 updates the record for the merchant identifier. For example, when the merchant identification system 140 has created a record for the merchant identifier and associated candidate merchant identifiers for the merchant identifier as described herein, the merchant identification system 140 updates the record to include the expected identity of the actual merchant associated with the merchant identity. The merchant identification system 140 can then access the stored record to process subsequently received merchant identifiers as described below (such as in method 400). For example, the merchant identification system 140 may, after determining that “John Doe's Steakhouse at 1115 Market Street” is the expected actual identity for merchant identifier “JDSH12345678,” update the record for merchant identifier “JDSH12345678” to reflect that merchant identifier “JDSH12345678” is associated with “John Doe's Steakhouse at 1115 Market Street.”

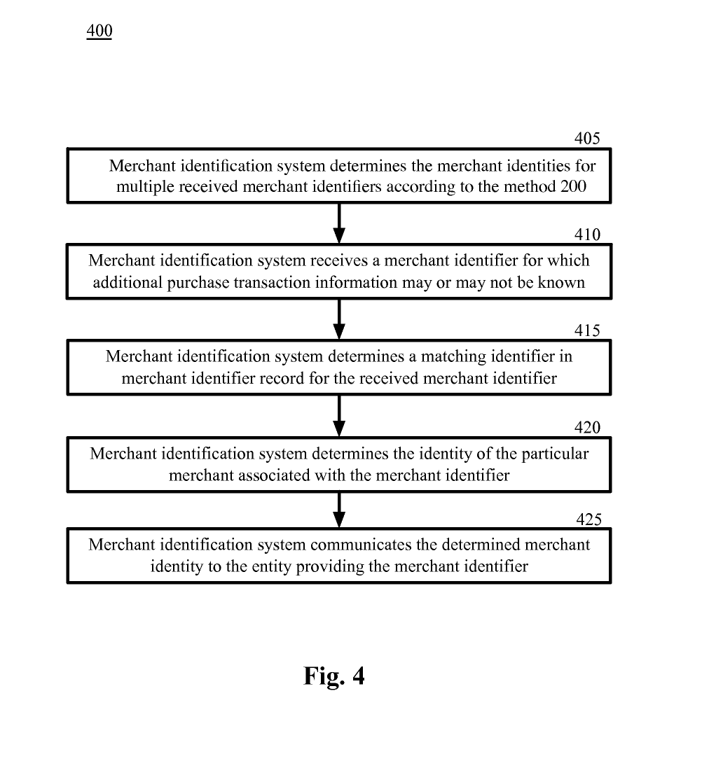

FIG. 4 is a block flow diagram depicting a method 400 for determining a merchant identity from a merchant identifier database, in accordance with certain example embodiments.

With reference to FIGS. 1 and 2, in block 405 of method 400, in certain example embodiments the merchant identification system 140 determines the merchant identities for multiple received merchant identifiers according to the method 200. That is, after receiving multiple of merchant identifiers, such as for different merchant point-of-sale terminals 134, the merchant identification system 140 determines—for each of the received merchant identifiers—the expected identity of the actual merchant associated with each of the merchant identifier. The merchant identification system 140 then creates a record each of the received merchant identifiers as described herein, such as a database of merchant identifiers.

For example, the merchant identification system 140 can create a database with records for numerous merchant identifiers, each of which includes information for the merchant identifier and the expected identity of the actual merchant associated with the merchant identifier. By accessing the database, the merchant identification system 140 can use the database to identify merchants for subsequently received merchant identifiers. The accessible database, for example, may be stored on the data storage unit 144 of the merchant identification system 140.

In block 410, after the creation of a merchant identifier database, the merchant identification system 140 receives a merchant identifier for which additional purchase transaction information may or may not be known. For example, the merchant identification system 140 may receive a merchant identifier from any entity, such as any entity having a commercial interest where purchase transactions are occurring.

When receiving the subsequent merchant identifier, the merchant identification system 140 may receive only the merchant identifier, such as a merchant identifier for a point-of-sale terminal 134, without any additional purchase transaction information whatsoever. In other words, the merchant identification system 140 may not receive any information regarding the user 101 or the user device 110 involved in the purchase transaction involving the subsequent merchant identifier. The merchant identification system 140 may also not receive any information regarding the time of the purchase transaction between a particular user 101 and merchant point-of-sale terminal 134. For example, after creating a record that associates merchant identifier “JDSH12345678” with “John Doe's Steakhouse at 1115 Market Street,” the merchant identification system 140 may subsequently receive merchant identifier “JDSH12345678” with or without any additional information regarding the “JDSH12345678” merchant identifier.

In block 415, the merchant identification system 140 determines a matching identifier in the merchant identification record for the subsequently received merchant identifier. That is, after the merchant identification system 140 receives a merchant identifier for which additional information may or may not be known, the merchant identification system 140 reads the merchant identifier. The merchant identification system 140 then searches the record of merchant identifiers, such as the database of merchant identifiers, for a stored merchant identifier that matches the subsequently received merchant identifier. For example, if the merchant identification system 140 subsequently receives merchant identifier “JDSH12345678,” the merchant identification system 140 can locate the previously stored record for merchant identifier “JDSH12345678.”

In block 420, once the merchant identification system 140 determines a stored merchant identifier that matches the subsequently received merchant identifier, the merchant identification system 140 determines the identity of the particular merchant, such as the identity of the merchant point-of-sale terminal 134, associated with the merchant identifier in the record. That is, the merchant identification system 140 reads the record for the matched merchant identifier to determine the identity of the merchant associated with the received merchant identifier. For example, when the merchant identification system 140 locates a record matching merchant identifier “JDSH12345678,” the merchant identification system 140 determines from the record that “John Doe's Steakhouse at 1115 Market Street” is the identity of the merchant associated with merchant identifier “JDSH12345678.” In other words, based on subsequently receiving the merchant identifier “JDSH12345678”—with or without any additional purchase transaction information—the merchant identification system 140 identifies “John Doe's Steakhouse at 1115 Market Street” as being associated with the “JDSH12345678” merchant identifier.

In block 425, in certain example embodiments, the merchant identification system 140 communicates the determined merchant identity, such as the identity of the merchant point-of-sale terminal 134, to the entity that provided the subsequently received merchant identifier. That is, after determining the identity of the merchant from the record of merchant identifiers, the merchant identification system 140 transmits the determined identity to the entity that provided the merchant identifier to the merchant identification system 140.

For example, after the merchant identification system 140 creates a record for merchant identifier “JDSH12345678,” an entity may provide a request for the identity of the merchant point-of-sale terminal associated with merchant identifier “JDSH12345678.” By relying on the record for the merchant identifier “JDSH12345678” as described herein, the merchant identification system 140 can determine that “John Doe's Steakhouse at 1115 Market Street” is associated with merchant identifier “JDSH12345678” and hence communicate such information to the entity providing the request. The entity can then use the determined merchant identity for the merchant identifier for a variety of purposes.

In certain example embodiments, the merchant identification system 140 (or other system) can use the determined merchant identity associated with the merchant identifier, such as the identity of the merchant point-of-sale terminal 134 associated with the merchant identifier, to determine the effectiveness of an advertising campaign. For example, without knowing the identity of a particular merchant associated with a merchant identifier, the merchant identification system 140 may not be able to discern between two or more particular merchant locations. In other words, without knowing the identity of at least one of the particular merchants, the entity may not be able to discern, for example, whether a purchase transaction—for received merchant identifier “JDSH12345678”—occurred at “John Doe's Steakhouse at 1115 Market Street” or at a separate “John Doe's Steakhouse at 131 Liberty Street” location. But with the determined identity of “John Doe's Steakhouse at 1115 Market Street” for merchant identifier “JDSH12345678,” the merchant identification system 140 can determine for subsequently received “JDSH12345678” merchant identifiers that the purchase transactions are occurring at the “John Doe's Steakhouse at 1115 Market Street” location. The merchant identification system 140 can then, for example, correlate advertising success for the particular “John Doe's Steakhouse at 1115 Market Street.”

For example, by knowing the particular merchant identity for received merchant identifiers, the merchant identification system 140 (or other system) can determine at what particular merchant point-of-sale 134 locations purchase transactions are occurring. Hence, the merchant identification system 140 can also determine—based on the number of received merchant identifiers, for example—the volume of purchase transactions occurring at different, specific merchants, such as at different retail locations for the same merchant chain in a given city. By then determining the volume of purchase transactions occurring at different merchants, the merchant identification system 140 can determine the locations at which an offer is having the most impact. For example, the merchant identification system 140 may determine that an offer such as “Get a Free Desert” is increasing purchase transactions at “John Doe's Steakhouse at 1115 Market Street” more so than at a separate “John Doe's Steakhouse at 131 Liberty Street” location.

The offer, for example, can be any type of offer, such as a ticket, coupon, discount, rebate, voucher, loyalty reward, special offer, prepaid offer, or any other type of promotion that can be exchanged for a financial discount or rebate when purchasing a product or service, for example. For online retailers or merchants, for example, the offer may be any type of coupon code, promotional or promo code, discount code, key code, reward code, or any other type code exchanged for a financial discount. The offer, including the offer content and any restrictions or conditions associated with the offer, can be created by any entity, such as an offer provider system (not shown).

In certain example embodiments, the merchant identification system 140 (or other system) may use the determined merchant identity associated with a merchant identifier to automatically manage loyalty rewards for a particular user 101. For example, based on receiving a merchant identifier as described herein, the merchant identification system 140 determines the identity of the merchant, such as the merchant point-of-sale terminal 134, that is associated with the merchant identifier. Then, by determining the identity of the user 101—and hence the identity of the user device 110 of the user 101 at the time of the purchase transaction as described herein—the merchant identification system 140 can determine that the user 101 was at the identified merchant at the time of the purchase transaction. The merchant identification system 140 can then, based on the purchase transaction between the user 101 and the identified merchant, provide loyalty rewards to the user 101 for the purchase transaction with the particular merchant.

For example, after creating a record for merchant identifier “JDSH12345678” as described in certain examples herein, the merchant identification system 140 may subsequently receive merchant identifier “JDSH12345678,” along with purchase transaction information for the received merchant identifier “JDSH12345678.” The merchant identification system 140 can then determine from the record for merchant identifier “JDSH12345678,” for example, that merchant identifier “JDSH12345678” corresponds to “John Doe's Steakhouse at 1115 Market Street.”

The merchant identification system 140 can then determine based on the purchase transaction information and as described herein that the user device 110 of the user 101 involved in the purchase transaction was at “John Doe's Steakhouse at 1115 Market Street” at the time of the purchase transaction. Hence, based on the purchase transaction of the user 101 at “John Doe's Steakhouse at 1115 Market Street,” the merchant identification system 140 can automatically assign the loyalty reward points to the user 101 for the purchase transaction. And when assigning the loyalty reward points, the merchant identification system 140 can do so specifically for “John Doe's Steakhouse at 1115 Market Street” and not the “John Doe's Steakhouse at 131 Liberty Street” location. As one skilled in the art will appreciate, the ability to determine the identity of a particular merchant, such as a merchant point-of-sale terminal 134, that is associated with a merchant identifier will have numerous applications in addition to the example embodiments described herein.

### Other Example Embodiments

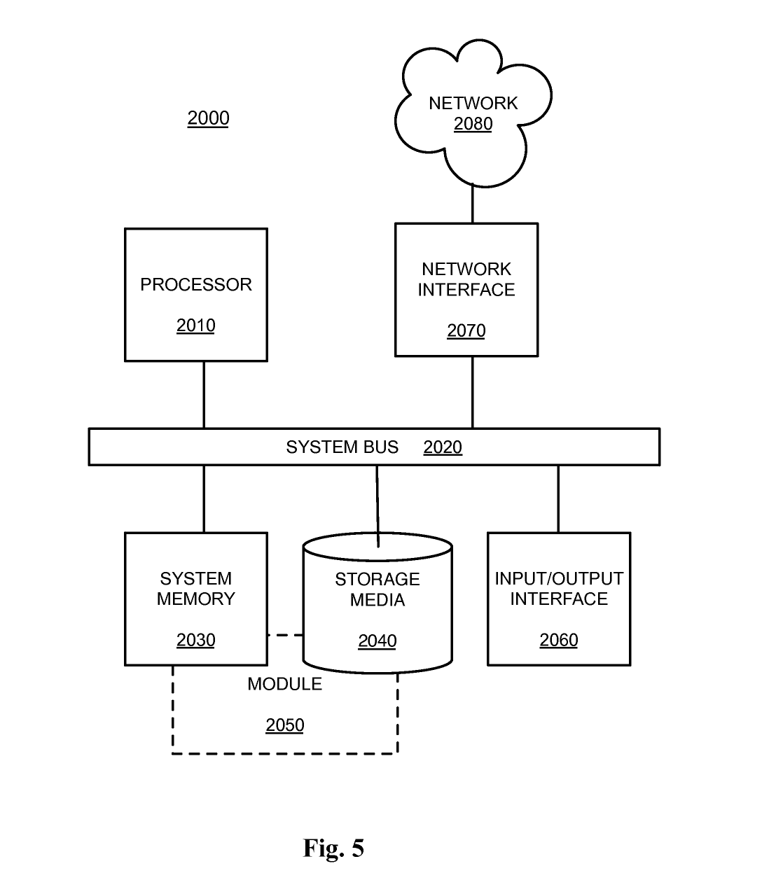

FIG. 5 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain example embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the examples described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to determine merchant identities for merchant identifiers, comprising:
receiving, by one or more computing devices, a plurality of merchant identifiers for a plurality of merchants, wherein each merchant identifier of the received merchant identifiers is unique to a particular one of the plurality of merchants and wherein each of the received merchant identifiers is received in connection with a purchase transaction involving a particular user at the particular merchant;
determining, by the one or more computing devices and for each of at least a portion of the received merchant identifiers, a location of a user computing device of the particular user involved in the purchase transaction, wherein the location corresponds to the location of the user computing device at the time of the purchase transaction with the particular merchant;
determining, for each of the at least a portion of the received merchant identifiers, by the one or more computing devices and based on the determined location of one or more user computing devices at the time of the purchase transaction, one or more candidate merchant identities for the particular merchant associated with the purchase transaction;
associating for each of at least a portion of the received merchant identifiers, by the one or more computing devices, the one or more candidate merchant identities with the received merchant identifier for the purchase transaction; and,
determining, by the one or more computing devices and when a threshold number of matching candidate identities are associated with the received merchant identifier, a merchant identity of the particular merchant associated with the received merchant identifier, wherein the determined merchant identity corresponds to at least one of the matching candidate merchant identities.

2. The method of claim 1, wherein the threshold number of matching candidate merchant identities comprises at least two candidate merchant identities that match each other.

3. The method of claim 1, wherein determining the location of the user computing device of the particular user at the time of the purchase transaction further comprises:
determining, by the one or more computing devices, the identity of the user involved in the purchase transaction, wherein the identity of the user is determined by matching a received financial account record of the user with a record for the user; and,
determining, by the one or more computing devices and based on the determined identity of the user, the user computing device of the user involved in the purchase transaction.

4. The method of claim 1, wherein determining the one or more candidate merchant identities for the particular merchant associated with the purchase transaction further comprises determining, by the one or more computing devices, a merchant name for a merchant that is at or near the determined location of the user device at the time of the purchase transaction.

5. The method of claim 4, further comprising determining, by the one or more computing devices, a street address that is associated with the determined merchant name.

6. The method of claim 1, further comprising:
determining, by the one or more computing devices and for each of the plurality of received merchant identifiers, an identity of each of the plurality of merchants associated with each of the plurality of the received merchant identifiers;
associating, by the one or more computing devices, the determined identity of each of the plurality of merchants with a record for each of the received merchant identifiers, wherein the record comprises the determined identity of each of the plurality of merchants that is associated with each of the received plurality of merchant identifiers.

7. The method of claim 6, further comprising:
receiving, by the one or more computing devices, a subsequent merchant identifier; and,
determining, by the one or more computing devices, an identity of a merchant associated with the subsequently received merchant identifier.

8. The method of claim 7, wherein determining the identity of the merchant associated with the subsequently received merchant identifier comprises:
determining, by the one or more computing devices, that the subsequently received merchant identifier matches one of the plurality of the received merchant identifiers in the record; and,
determining, by the one or more computing devices and from the record matching the subsequently received merchant identifier, the identity of the merchant associated with subsequently received merchant identifier.

9. A system for determining a merchant identity for a merchant identifier, comprising:
a storage device;
a processor communicatively coupled to the storage device, wherein the processor executes application code instructions that are stored in the storage device to cause the system to:
receive a first merchant identifier for a merchant, wherein the first merchant identifier is unique to the merchant and wherein the first merchant identifier is received in response to a first purchase transaction involving a first user at the merchant;
determine, for the first merchant identifier, a first location of a first user computing device of the first user involved in the first purchase transaction with the merchant, wherein the first location corresponds to the location of the first user computing device at the time of the first purchase transaction with the merchant;
determine, based on the determined first location of the first user computing device at the time of the first purchase transaction with the merchant, a first candidate merchant identity for the merchant;
receive a second merchant identifier for the merchant, wherein the second merchant identifier corresponds to the first merchant identifier and wherein the second merchant identifier is received in response to a second purchase transaction involving a second user at the merchant;
determine, for the second merchant identifier, a second location of a second user computing device of the second user involved in the second purchase transaction with the merchant, wherein the second location corresponds to the location of the second user computing device at the time of the second purchase transaction with the merchant;
determine, based on the determined second location of the second user computing device at the time of the second purchase transaction with the merchant, a second candidate merchant identity for the merchant,
determine that the first determined candidate merchant identity matches the second determined candidate identity; and,
determine, based on the matching first determined candidate merchant identity and the second determined candidate identity, a merchant identity of the merchant associated with the received first and second merchant identifiers.

10. The system of claim 9, further comprising associating the first received merchant identifier with the first purchase transaction and the second received merchant identifier with the second purchase transaction.

11. The system of claim 9, wherein determining the first location of the first user computing device of the first user at the time of the first purchase transaction further comprises:
determining a first identity of the first user involved in the first purchase transaction, wherein the first identity of the first user is determined by matching a first financial account record of the first user with a first record for the first user; and
determining, based on the determined first identity of the first user, the first user computing device of the first user involved in the first purchase transaction.

12. The system of claim 11, wherein determining the second location of the second user computing device of the second user at the time of the second purchase transaction further comprises:
determining a second identity of the second user involved in the second purchase transaction, wherein the second identity of the second user is determined by matching a second financial account record of the second user with a second record for the second user; and
determining, based on the determined second identity of the second user, the second user computing device of the second user involved in the second purchase transaction.

13. The system of claim 9, further comprising associating the first or second received merchant identifier with the determined identity of the merchant in a record of merchant identifiers.

14. The system of claim 13, further comprising:
receiving a subsequent merchant identifier for a second merchant;
determining that the subsequently received merchant identifier matches the first or second received merchant identifiers in the record of merchant identifiers; and,
determining, from the record matching the subsequently received merchant identifier, the identity of the second merchant associated with subsequently received merchant identifier.

15. A computer program product, comprising:
a non-transitory computer-readable storage device having computer-readable program instructions embodied thereon that when executed by a computer cause the computer to determine merchant identities for merchant identifiers, the computer-executable program instructions comprising:
computer-executable program instructions to receive a plurality of merchant identifiers for a plurality of merchants, wherein each merchant identifier of the received merchant identifiers is unique to a particular one of the plurality of merchants and wherein each of the received merchant identifiers is received in response to a purchase transaction involving a particular user at the particular merchant;
computer-executable program instructions to determine, for each of at least a portion of the received merchant identifiers for a particular merchant, a location of a user computing device of the particular user involved in the purchase transaction, wherein the location corresponds to the location of the user computing device at the time of the purchase transaction with the particular merchant;
computer-executable program instructions to determine, based on the determined location of one or more user computing devices at the time of the purchase transaction, one or more candidate merchant identities for the particular merchant associated with the purchase transaction;
computer-executable program instructions to associate the one or more candidate merchant identities with the received merchant identifier for the purchase transaction; and,
computer-executable program instructions to determine, when a threshold number of matching candidate identities are associated with the received merchant identifier, a merchant identity of the particular merchant associated with the received merchant identifier, wherein the determined merchant identity corresponds to at least one of the matching candidate merchant identities.

16. The computer-executable program product of claim 15, wherein the threshold number of matching candidate merchant identities comprises at least two candidate merchant identities that match each other.

17. The computer-executable program product of claim 15, wherein determining the one or more candidate merchant identities for the particular merchant associated with the purchase transaction further comprises determining merchant name or street address for a merchant that is at or near the determined location of the user device at the time of the purchase transaction.

18. The computer-executable program product of claim 15, further comprising:
determining, for each of the plurality of received merchant identifiers, an identity of each of the plurality of merchants associated with each of the plurality of the received merchant identifiers;
associating the determined identity of each of the plurality of merchants with a record for each of the received merchant identifiers, wherein the record comprises the determined identity of each of the plurality of merchants that is associated with each of the received plurality of merchant identifiers.

19. The computer-executable program product of claim 18, further comprising:
receiving a subsequent merchant identifier; and,
determining an identity of a merchant associated with the subsequently received merchant identifier.

20. The computer-executable program product of claim 19, wherein determining the identity of the merchant associated with the subsequently received merchant identifier comprises:
determining that the subsequently received merchant identifier matches one of the plurality of the received merchant identifiers in the record; and,
determining, from the record matching the subsequently received merchant identifier, the identity of the merchant associated with subsequently received merchant identifier.
